(19) United States
(12) Patent Application Publication
(10) Pub. No.: US 2019/0366956 A1
(43) Pub. Date: Dec. 5, 2019

(54) VEHICLE POWER AND CONTROL METHOD THEREOF

(71) Applicants: HYUNDAI MOTOR COMPANY, Seoul (KR); KIA MOTORS CORPORATION, Seoul (KR)

(72) Inventor: Jin KIM, Suwon-si (KR)

(73) Assignees: HYUNDAI MOTOR COMPANY, Seoul (KR); KIA MOTORS CORPORATION, Seoul (KR)

(21) Appl. No.: 16/120,908

(22) Filed: Sep. 4, 2018

(30) Foreign Application Priority Data
May 30, 2018 (KR) 10-2018-0061529

(51) Int. Cl. B60R 16/033; B60L 11/18

(52) U.S. Cl. CPC B60R 16/033; B60L 2250/16; B60L 11/1861

(57) ABSTRACT

A vehicle and a control method of the vehicle are disclosed. In particular, the vehicle includes: a generator; a battery; a plurality of electronic components; a power distribution apparatus to distribute power from the generator and the battery to the plurality of electronic components; and a power management apparatus to determine an electrical characteristic of each of the generator, the battery and the power distribution apparatus, and a power supply relationship between the generator, the battery and the power distribution apparatus.

### CROSS-REFERENCE TO RELATED APPLICATION

This application claims priority to and the benefit of Korean Patent Application No. 10-2018-0061529, filed on May 30, 2018, the entire contents of which are incorporated by reference.

### FIELD

The present disclosure relates to a vehicle and a control method thereof.

### BACKGROUND

The statements in this section merely provide background information related to the present disclosure and may not constitute prior art.

In general, a vehicle is transportation means or moving means that runs on a road or a rail using fossil fuel or electricity as a power source.

The vehicle includes a starter motor for starting, and is equipped with various electronic components for protecting a driver and providing the driver with convenience and entertainment. The vehicle also includes a generator for producing power to be supplied to the starter motor and electronic components, and a battery for storing power produced by the generator.

The electronic components, the generator and the battery form a power network in the vehicle.

For example, the power network configuration of a vehicle is designed based on the specifications of various electronic components (a generator, a battery, a controller, electrical loads, etc.) for improving a power distribution apparatus and wiring harness. The power network of a vehicle is becoming complicated more and more due to an increase of electronic components installed in the vehicle and the diversity of power control methods. Also, in order to support fault tolerance of autonomous vehicles in the future, the redundancy of a power network (e.g., extra power network/components) should be provided.

Typical vehicles did not provide the redundancy of a power network because drivers themselves drive the vehicles, and provided fail safe for limiting the operation of the system only in abnormal conditions. However, we have discovered that autonomous vehicles need to provide fault detection, fault isolation, and fault recovery. Therefore, a vehicle itself needs to identify the structure of a power network and the flow of power.

### SUMMARY

The present disclosure provides a vehicle capable of detecting, when a fault occurs, a fault location and performing a safety operation, and a method of determining a power supply relationship of the vehicle.

It is another aspect of the present disclosure to provide a vehicle capable of identifying the structure of a power network and the flow of power, and a method of determining a power supply relationship of the vehicle.

Additional aspects of the present disclosure will be set forth in part in the description which follows and, in part, will be obvious from the description, or may be learned by practice of the disclosure.

In accordance with one aspect of the present disclosure, there may be provided a vehicle comprising: a generator; a battery; a plurality of electronic components; at least one power distribution apparatus to distribute power from the generator and the battery to the plurality of electronic components; and a power management apparatus to determine electrical characteristics of each of the generator, the battery and the at least one power distribution apparatus, and configured to determine a power supply relationship between the generator, the battery and the at least one power distribution apparatus.

The electrical characteristics comprise a number of power distribution apparatus within the vehicle, the maximum power output amount of the at least one power distribution apparatus, power input/output characteristics of the at least one power distribution apparatus, and the maximum voltage variation of the at least one power distribution apparatus.

The power management apparatus may determine the number of the power distribution apparatus within the vehicle based on communication data received from the at least one power distribution apparatus.

The power management apparatus may identify the maximum power output amount of the at least one power distribution apparatus based on the input/output current and the applied voltage of the at least one power distribution apparatus.

The power management apparatus may identify the power input/output characteristics of the at least one power distribution apparatus based on the input/output current of the at least one power distribution apparatus.

The power management apparatus may identify the maximum voltage variation of the at least one power distribution apparatus based on the applied voltage of the at least one power distribution apparatus.

The power management apparatus may determine the power supply relationship between at least one power distribution apparatus based on the number of the power distribution apparatus within the vehicle and the power input/output characteristics of the at least one power distribution apparatus.

The power management apparatus may determine the power supply relationship between the at least one power distribution apparatus and the battery based on the maximum power output amount of the at least one power distribution apparatus.

The power management apparatus may determine the power supply relationship between the at least one power distribution apparatus and the battery based on based on the maximum voltage variation of the at least one power distribution apparatus.

The vehicle may further comprise a display, and the power management apparatus may display on the display an image representing the power supply relationship between the generator, the battery, and the at least one power distribution apparatus.

In another aspect of the present disclosure, there may be provided a control method of a vehicle which includes a generator, a battery, a plurality of electronic components, and at least one power distribution apparatus to distribute power from the generator and the battery to the plurality of electronic components. The method may comprises: distributing power, by the at least one power distribution apparatus, from the generator and the battery to the plurality of electronic components; and determining, by the power management apparatus, electrical characteristics of each of the generator, the battery and the at least one power distribution apparatus, and a power supply relationship between the generator, the battery and the at least one power distribution apparatus.

The electrical characteristics may comprise a number of power distribution apparatus within the vehicle, the maximum power output amount of the at least one power distribution apparatus, power input/output characteristics of the at least one power distribution apparatus, and the maximum voltage variation of the at least one power distribution apparatus.

The control method may further comprise determining, by the power management apparatus, the number of the power distribution apparatus within the vehicle based on communication data received from the at least one power distribution apparatus.

The control method may further comprise identifying, by the power management apparatus, the maximum power output amount of the at least one power distribution apparatus based on the input/output current and the applied voltage of the at least one power distribution apparatus.

The control method may further comprise identifying, by the power management apparatus, the power input/output characteristics of the at least one power distribution apparatus based on the input/output current of the at least one power distribution apparatus.

The control method may further comprise identifying, by the power management apparatus, the maximum voltage variation of the at least one power distribution apparatus based on the applied voltage of the at least one power distribution apparatus.

The control method may further comprise determining, by the power management apparatus, the power supply relationship between at least one power distribution apparatus based on the number of the power distribution apparatus within the vehicle and the power input/output characteristics of the at least one power distribution apparatus.

The control method may further comprise determining, by the power management apparatus, the power supply relationship between the at least one power distribution apparatus and the generator based on the maximum power output amount of the at least one power distribution apparatus.

The control method may further comprise determining, by the power management apparatus, the power supply relationship between the at least one power distribution apparatus and the battery based on the maximum voltage variation of the at least one power distribution apparatus.

The control method may further comprise displaying on a display an image representing a power supply relationship between the generator, the battery, and the at least one power distribution apparatus.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates main components of a vehicle;

FIG. 2 illustrates electronic components of a vehicle;

FIG. 3 illustrates an example of a power network of a vehicle;

FIGS. 4A-4D illustrate other examples of a power network of a vehicle;

FIG. 5 illustrates a power distribution apparatus of a vehicle;

FIG. 6 illustrates a power management apparatus of a vehicle;

FIG. 7 illustrates a power network characteristic table stored in a power management apparatus of a vehicle;

FIG. 8 illustrates an example of a power network structure matrix stored in a power management apparatus of a vehicle;

FIGS. 9A-9D illustrate examples of information on a power network displayed on a display of a vehicle;

FIG. 10 illustrates another example of a power network structure matrix stored in a power management apparatus of a vehicle;

FIGS. 11A-11C illustrate other examples of information on a power network displayed on a display of a vehicle;

FIG. 12 illustrates an example in which the power network of a vehicle is changed;

FIG. 13 illustrates an example in which the power network characteristic table is changed by the change of the power network illustrated in FIG. 12; and

FIG. 14 illustrates an example in which the power network structure matrix is changed by the change of the power network illustrated in FIG. 12.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

This specification does not describe all components of forms, and general information in the technical field to which the present disclosure belongs or overlapping information between the forms will not be described. The terms “portion”, “module”, “member”, and “block”, as used herein, may be implemented as software or hardware, and according to forms, a plurality of “portions”, “modules”, “members”, or “blocks” may be implemented as a single component, or a single “portion”, “module”, “member”, or “block” may include a plurality of components.

Throughout this specification, when a portion is “connected” to another portion, this includes the case in which the portion is indirectly connected to the other portion, as well as the case in which the portion is directly connected to the other portion, and the indirect connection includes a connection through a wireless communication network.

Also, it will be understood that when the terms “includes,” “comprises,” “including,” and/or “comprising,” when used in this specification, specify the presence of a stated component, but do not preclude the presence or addition of one or more other components.

In the present disclosure, it will also be understood that when an element is referred to as being “on” or “over” another element, it can be directly on the other element or intervening elements may also be present.

It will be understood that, although the terms first, second, etc. may be used herein to describe various components, these components should not be limited by these terms. These terms are only used to distinguish one component from another.

It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Hereinafter, the operation principle and forms of the present disclosure will be described with reference to the accompanying drawings.

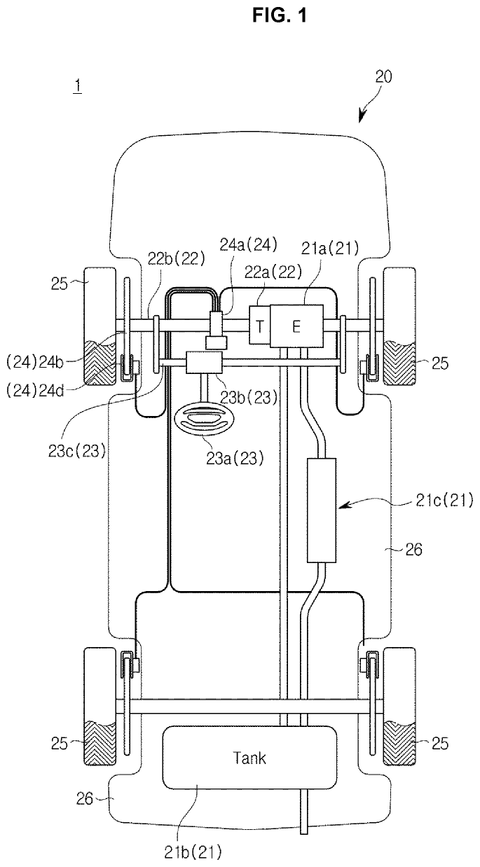

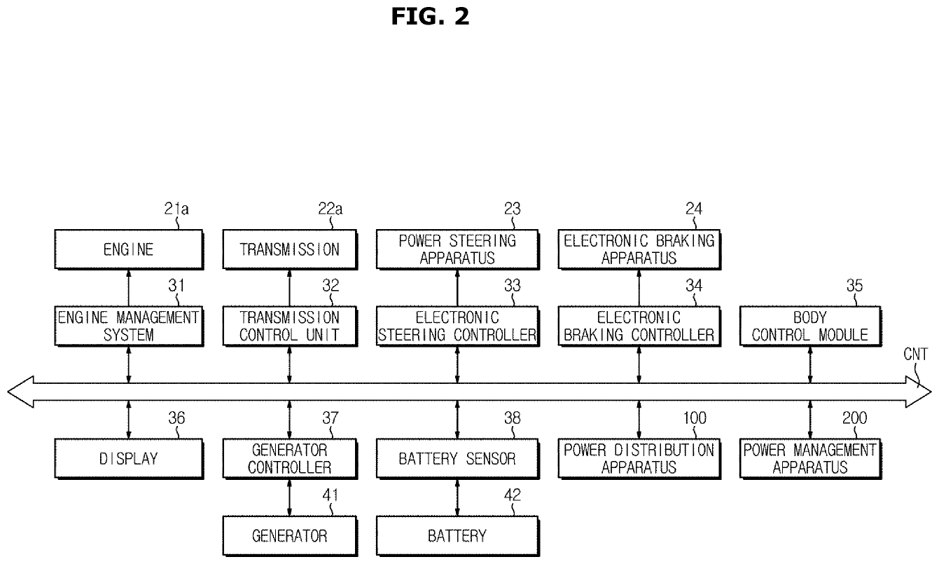

FIG. 1 shows main components of a vehicle according to an form, and FIG. 2 shows electronic components of a vehicle in one form of the present disclosure.

Referring to FIGS. 1 and 2, a vehicle 1 may include a body forming an appearance of the vehicle 1 and accommodating a driver and/or baggage, a chassis 20 including components of the vehicle 1 except for the body, and electronic components 30 for protecting the driver or providing the driver with convenience.

The chassis 20 may include apparatuses for generating power to drive the vehicle 1 according to the driver's control and for driving/braking/steering the vehicle 1 using the power. For example, as shown in FIG. 1, the chassis 20 may include a power generating apparatus 21, a power transmitting apparatus 22, a power steering apparatus 23, an electronic braking apparatus 24, a plurality of wheels 25, and a frame 26.

The power generating apparatus 21 may generate a rotational force for driving the vehicle 1, and may include an engine 21a, a fuel supply device 21b, and an exhaust device 21c.

The power transmitting apparatus 22 may transmit the rotational force generated by the power generating apparatus 21 to the wheels 25, and may include a transmission 22a, a shift lever, a differential device, and a drive shaft 22b.

The power steering apparatus 23 may control a traveling direction of the vehicle 1 and may include a steering wheel 23a, a steering gear 23b, and a steering link 23c.

The electronic braking apparatus 24 may stop the wheels 25, and may include a brake pedal, a master cylinder 24a, a brake disk 24b, and a brake pad 24c.

The wheels 25 may receive a rotational force from the power generating apparatus 21 through the power transmitting apparatus 22, and may move the vehicle 1. The wheels 25 may include front wheels disposed in a front portion of the vehicle 1 and rear wheels disposed in a rear portion of the vehicle 1.

The frame 26 may fix the power generating apparatus 21, the power transmitting apparatus 22, the power steering apparatus 23, the electronic braking apparatus 24, and the wheels 25.

The vehicle 1 may include the various electronic components 30 (first, second and third electronic components 30a, 30b and 30c) for the control of the vehicle 1 and for the safety and convenience of the driver and passengers, in addition to the mechanical components described above.

For example, as shown in FIG. 2, the vehicle 1 may include an engine management system (EMS) 31, a transmission control unit (TCU) 32, an electronic steering controller 33, an electronic braking controller 34, a body control module (BCM) 35, a display 36, a generator 41, a generator controller 37, a battery 42, a battery sensor 38, a power distribution apparatus 100, and a power management apparatus 200.

The engine management system 31 may control the operation of the engine 21a in response to the drivers acceleration command through an accelerator pedal, and may manage the engine 21a. For example, the engine management system 31 may perform engine torque control, fuel consumption control, engine failure diagnosis, and/or generator control.

The transmission control unit 32 may control the operation of the transmission 22a in response to the drivers shift command through the shift lever or the driving speed of the vehicle 1. For example, the transmission control unit 32 may perform clutch control, shift control, and/or engine torque control during shifting.

The electronic steering controller 33 may control the power steering apparatus 23 for assisting the driver to easily operate the steering wheel 23a, For example, the electronic steering controller 33 may control the power steering apparatus 23 to reduce a steering force during low-speed traveling or parking and to increase a steering force during high-speed driving.

The electronic braking controller 34 may control the electronic braking apparatus 24 of the vehicle 1 in response to the drivers braking command through the braking pedal, and maintain the balance of the vehicle 1. For example, the electronic braking controller 34 may perform automatic parking brake control, slip prevention during braking, and/or slip prevention during steering.

The body control module 35 may control operations of electronic components for providing the driver with convenience or securing the driver's safety. For example, the body control module 35 may control door lock devices, head lamps, wipers, power seats, seat heaters, a cluster, a room lamp, navigation system, a multifunctional switch, and the like, which are installed in the vehicle 1.

The display 36 may be installed at a center fascia inside the vehicle 1 to provide the driver with various information and entertainment through a screen. For example, the display 36 may replay a video file stored in internal storage medium or external storage medium according to the driver's command, and may output images included in the video file. In addition, the display 36 may display information about a topology of a power network (PNT) of the vehicle 1.

The generator 41 may receive a rotational force from the engine 21a, and may generate power from the rotational force. In addition, the generator 41 may supply power to the electronic components 30 included in the vehicle 1.

The generator 41 may include a rotor connected to the engine 21a and rotating according to whether or not the engine 21a rotates, and a stator fixed without rotating. In addition, the generator 41 may include a field magnet for generating a magnetic field, and an armature moving relative to a magnetic field of the field magnet and generating power.

In particular, the field magnet may include field coils, and an intensity of a magnetic field generated by the field magnet may vary depending on a magnitude of current flowing through the field coils. In addition, a magnitude of a voltage and/or current generated by the armature may vary depending on the intensity of the magnetic field generated by the field magnet.

The generator controller 37 may control operations of the generator 41. For example, the generator controller 37 may regulate a magnitude of current flowing through the field coils of the generator 41, and may control power production of the generator 41 by controlling the current of the field coils. That is, the generator controller 37 nay control magnitudes of a voltage and current output from the generator 41.

The battery 42 may store the power produced by the generator 41. In addition, the battery 42 may supply the power to the electronic components 30 included in the vehicle 1, For example, when the vehicle 1 travels, the generator 41 may produce power by a rotation of the engine 21a and the battery 42 may receive the power from the generator 41 to store the power (electric energy). In addition, the battery 42 may supply power for starting to the starter motor in order to drive the vehicle 1, or may supply power to the electronic components 30 of the vehicle 1.

The battery sensor 38 may acquire state information associated with the battery 42, The battery sensor 38 may include a voltage sensor for measuring an output voltage of the battery 42, a current sensor for measuring an input/output current of the battery 42, a temperature sensor for measuring temperature of the battery 42, and the like. In addition, the battery sensor 38 may include a sensor controller for calculating a state of charge (SoC) of the battery 42, a state of health (SoH) of the battery 42, and the like based on state information of the battery 42.

The power distribution apparatus 100 may distribute/supply power from the generator 41 and/or the battery 42 to the electronic components 30. For example, the power distribution apparatus 100 may allow or block power supply from the generator 41 and/or the battery 42 to the electronic components 30.

The vehicle 1 may include a single power distribution apparatus 100 or a plurality of power distribution apparatuses 100. The plurality of power distribution apparatuses 100 may be connected to each other in various forms, and a power network (PNT) of the vehicle 1 may be formed by combining the plurality of power distribution apparatuses 100.

The power distribution apparatuses 100 will be described in more detail below.

The power management apparatus 200 may collect information about a power network (PNT) of the vehicle 1 and identify a connection structure of the power network (PNT) based on the information about the power network (PNT). For example, the power management apparatus 200 may collect operation information of the power distribution apparatus(es) 100, and identify a topology of a power network (PNT) of the vehicle 1 based on the operation information of the individual power distribution apparatus(es) 100. In addition, the power management apparatus 200 may identify a connection structure of the power distribution apparatus(es) 100 of the vehicle 1 based on the topology of the power network (PNT).

The power management apparatus 200 will be described in more detail below.

The electronic components 30 may communicate with each other through a vehicle communication network (CNT). For example, the electronic components 30 may transmit/receive data to/from each other through Ethernet, MOST (Media Oriented Systems Transport), Flexray, CAN (Controller Area Network), LIN (Local Interconnect Network), and the like.

The power network (PNT) of the vehicle 1, the power distribution apparatuses 100, and the power management apparatus 200 will be described below

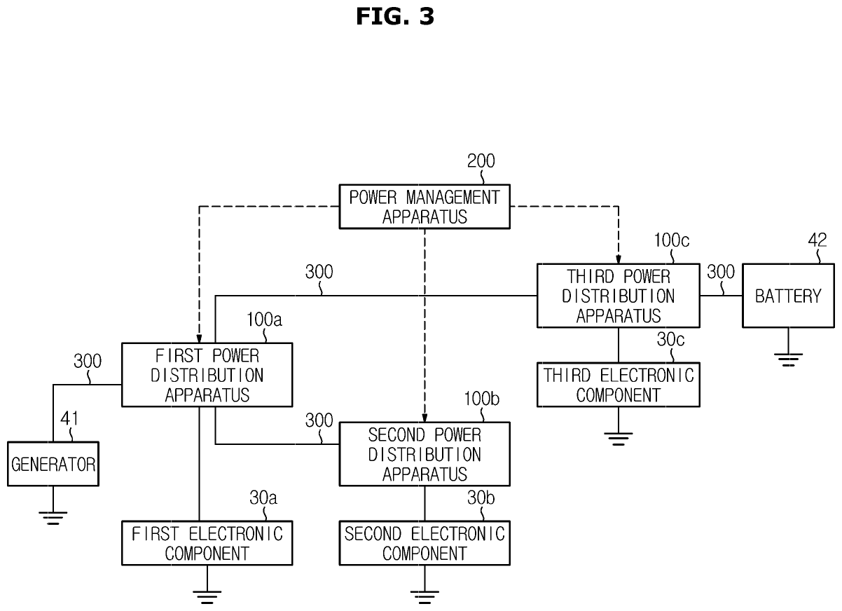

FIG. 3 shows an example of a power network (PNT) of a vehicle in one form of the present disclosure.

As shown in FIG, 3, the power network (PNT) may include the generator 41, the battery 42, the power distribution apparatuses 100 (first, second and third power distribution apparatuses 100a, 100b and 100c), the power management apparatus 200, and a plurality of power lines 300 connecting the generator 41, the battery 42, and the first, second and third power distribution apparatuses 100a, 100b and 100c to each other.

The generator 41 may produce power, and the power produced by the generator 41 may be transmitted to the first power distribution apparatus 100a through the power lines 300.

The battery 42 may receive the power from the generator 41 and thus be charged by the power of the generator 41. In addition, when the generator 41 does not produce any power or produces a small amount of power (for example, during parking or low-speed running), the battery 42 may output power to the third power distribution apparatus 100c.

The first power distribution apparatus 100a may receive power from the generator 41, and transmit the power to the first electronic component 30a, the second power distribution apparatus 100b and the battery 42. Further, the first power distribution apparatus 100a may transmit the power to the third power distribution apparatus 100c.

The second power distribution apparatus 100b may receive power from the first power distribution apparatus 100a, and transmit the power to the second electronic component 30b.

The third power distribution apparatus 100c may receive power from the battery 42 and/or the first power distribution apparatus 100a, and transmit the power to the third electronic component 30c and/or the battery 42.

The power management apparatus 200 may control the first power distribution apparatus 100a the second power distribution apparatus 100b, and the third power distribution apparatus 100c.

The power management apparatus 200 may collect operation information of the generator 41, the battery 42, the first power distribution apparatus 100a, the second power distribution apparatus 100b, and the third power distribution apparatus 100c, and may identify a connection structure of the generator 41, the battery 42, the first power distribution apparatus 100a, the second power distribution apparatus 100b and the third power distribution apparatus 100c based on the collected operation information. For example, the power management apparatus 200 may determine that the generator 41, the battery 42, and the first power distribution apparatus 100a are connected to each other, that the first power distribution apparatus 100a and the second power distribution apparatus 100b are connected to each other, and that the second power distribution apparatus 100b and the third power distribution apparatus 100c are connected to each other.

However, the power network (PNT) shown in FIG. 3 is merely an example for explaining the power distribution apparatus 100 and the power management apparatus 200, and the power network (PNT) of the vehicle 1 is not limited to the example shown in FIG. 3.

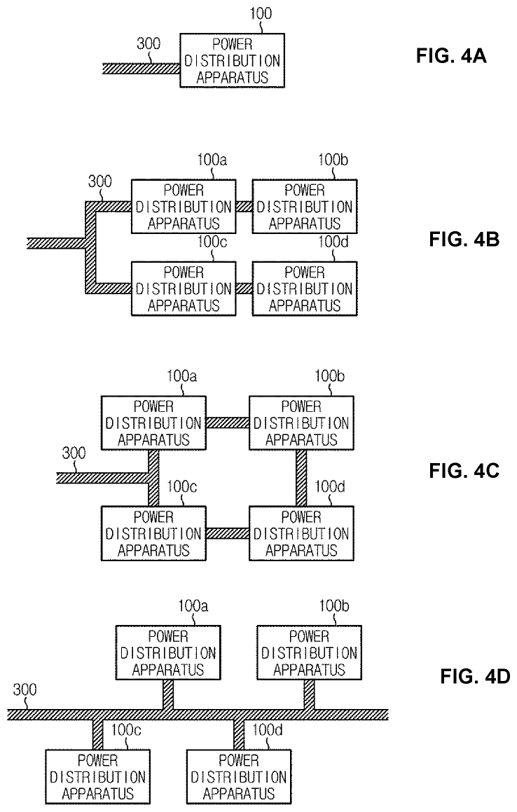

FIGS. 4A to 4D show other examples of a power network of a vehicle in exemplary forms of the present disclosure.

Referring to FIG. 4A, a power network (PNT) may include a single power distribution apparatus 100, wherein the power distribution apparatus 100 may transmit power to all the electronic components 30. The power network (PNT) of this topology is called a centralized power network.

As illustrated in FIG. 4B, a power network (PNT) may include a plurality of power distribution apparatuses 100a, 100b, 100c and 100d, wherein one of the plurality of power distribution apparatuses 100a, 100b, 100c and 100d may diverge into the other power distribution apparatuses and thus the power distribution apparatuses 100a, 100b, 100c and 100d may be connected to each other. The power network (PNT) of this topology is called a decentralized power network.

Referring to FIG. 4C, a power network (PNT) may include a plurality of power distribution apparatuses 100a, 100b, 100c and 100d, wherein the plurality of power distribution apparatuses 100a, 100b 100c and 100d may be connected to each other in the shape of a ring. The power network (PNT) of this topology is called a ring type power network.

As shown in FIG. 4D, a power network (PNT) may include a plurality of power distribution apparatuses 100a, 100b, 100c and 100d, wherein the plurality of power distribution apparatuses 100a, 100b, 100c and 100d may diverge from a single power line and be connected to each other. The power network (PNT) of this topology is called a backbone type power network.

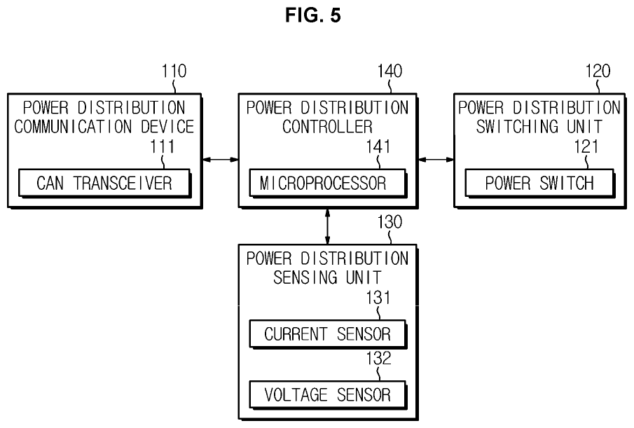

FIG. 5 shows a power distribution apparatus of a vehicle in another form of the present disclosure.

According to FIG. 5, the power distribution apparatus 100 may include a power distribution communication device 110 for transmitting/receiving data to/from the other electronic components 30 through a communication network (CNT), a power distribution switching device 120 for allowing or blocking power transmission to the other electronic components, a power distribution sensor 130 for measuring a current and voltage supplied to the power distribution apparatus 100, and a power distribution controller 140 for determining power transmission to the other electronic components 30.

The power distribution communication device 110 may include a CAN transceiver 111 for receiving a communication signal from the other electronic components and transmitting a communication signal to the other electronic components 30 through a communication network (CNT), and a CAN controller for controlling operations of the CAN transceiver 111.

The CAN transceiver 111 may receive a communication signal from the other electronic components 30 through the communication network (CNT) and output the communication signal to the power distribution controller 140. Also, the CAN transceiver 111 may receive a communication signal from the power distribution controller 140, and transmit the communication signal to the other electronic components 30 through the communication network (CNT). For example, the CAN transceiver 111 may receive a request for blocking power transmission from the power management apparatus 200 to the first electronic component 30a, and output the request to the power distribution controller 140. Further, the CAN transceiver 111 may receive communication data about an input current value and/or an input voltage value from the power distribution controller 140, and transmit the communication data to the power management apparatus 200.

The power distribution switching portion 120 may include a plurality of power switches 121 for allowing or blocking power transmission to the other electronic components 30 according to a control signal of the power distribution controller 140, and a drive circuit for driving the power switches 121.

The power switches 121 may be turned on or off in response to a control signal of the power distribution controller 140. For example, the power switches 121 which are in a turned-on state may be turned off in response to a power blocking signal of the power distribution controller 140.

In addition, each power switch 121 may include a power transistor or a relay.

The power distribution sensor 130 may include a current sensor 131 for measuring current supplied to the power distribution apparatus 100, and a voltage sensor 132 for measuring a voltage applied to the power distribution apparatus 100.

The power distribution sensor 130 may output an input current value measured by the current sensor 131 and an input voltage value measured by he voltage sensor 132 to the power distribution controller 140.

The power distribution controller 140 may include a microprocessor 141 for generating a control signal for controlling operations of the power distribution switching portion 120 according to a communication signal received through the power distribution communication device 110.

The microprocessor 141 may process the communication signal received by the power distribution communication device 110, and generate a control signal for controlling on/off of the power distribution switching portion 120 in accordance with the processed communication signal. For example, in response to a request for blocking power transmission to the first electronic component 30a received by the power distribution communication device 110, the microprocessor 141 may generate a control signal for turning off the power switch that transmits power to the first electronic component 30a.

Also, the microprocessor 141 may generate communication data to transmit an input current value and an input voltage value received from the power distribution sensor 130 to the power management apparatus 200 through the power distribution communication device 110, and may output the communication data to the power distribution communication device 110.

The microprocessor 141 may include a processor for performing logic operations and arithmetic operations, a memory for storing programs and data, and the like.

As described above, the power distribution apparatus 100 may transmit power supplied from the generator 41, the battery 42 and/or another power distribution apparatus to the electronic components 30 and/or another power distribution apparatus. Also, the power distribution apparatus 100 may transmit a current value and a voltage value of power supplied from the generator 41, the battery 42 and/or another power distribution apparatus to the power management apparatus 200.

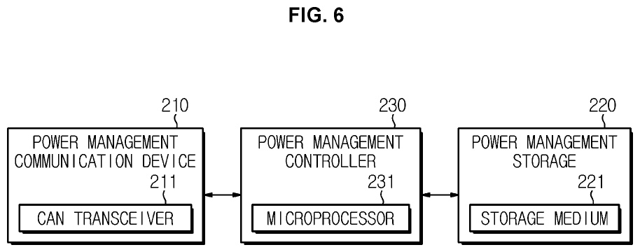

FIG. 6 shows a power management apparatus of a vehicle in one form of the present disclosure.

Referring to FIG. 6, the power management apparatus 200 may include a power management communication device 210 for transmitting/receiving data to/from the other electronic components 30 through the communication network (CNT), a power management storage 220 for storing information about the power distribution apparatus 100 and information about the power network (PNT), and a power management controller 230 for determining a topology of the power network (PNT).

The power management communication device 210 may include a CAN transceiver 211 for receiving a communication signal from the other electronic components 30 and transmitting a communication signal to the other electronic components 30 through the communication network (CNT), and a CAN controller for controlling the operation of the CAN transceiver 211.

The CAN transceiver 211 may receive a communication signal from the other electronic components 30 through the communication network (CNT), and output the communication signal to the power management controller 230. In addition, the CAN transceiver 211 may receive a communication signal from the power management controller 230 and transmit the communication signal to the other electronic components 30 through the communication network (CNT). For example, the CAN transceiver 211 may receive communication data about an input current value and/or an input voltage value from the power distribution apparatus 100, and transmit the communication data to the power management controller 230.

The power management storage 220 may include storage medium 221 for storing information about the power distribution apparatus 100 and information about the power network (PNT), and a storage controller for controlling storage/deletion/loading of data stored in the storage medium 221.

The storage medium 221 may store a power network characteristic table that includes information about the power distribution apparatus 100 and information about the power network (PNT). The power network characteristic table may include a topology of the power network (PNT), the number of the power distribution apparatuses within the vehicle, the number of the batteries 42, the number of power sources (e.g. generators, solar cells, etc.), a current power output amount of each of the power distribution apparatuses, a maximum power output amount of each of the power distribution apparatuses, a power input/output type of each of the power distribution apparatuses, a current power direction of each of the power distribution apparatuses, a current voltage variation of each of the power distribution apparatuses, and a maximum voltage variation of each of the power distribution apparatuses.

Also, the storage medium 221 may store a power network structure matrix that includes information about a connection structure between the power distribution apparatuses. The power network structure matrix may include a longitudinal axis and a transverse axis, wherein the longitudinal axis may include the power distribution apparatuses, the battery 42, and the generator 41, and the transverse axis may include the power distribution apparatuses and power lines between the power distribution apparatuses. In addition, the power network structure matrix may represent whether the configurations of the transverse axis are connected to those of the longitudinal axis.

The storage medium 221 may update the power network characteristic table and the power network structure matrix according to an update control signal of the power management controller 230, or output the power network characteristic table and the power network structure matrix according to a read control signal.

The storage medium 221 may include a flash memory, a solid state drive (SSD), a hard disk drive (HDD), and the like.

The power management controller 230 may include a microprocessor 231 that processes communication data of the power management communication device 210 and stored data of the power management storage 220 and generates a communication signal for controlling the power distribution apparatuses 100.

The microprocessor 231 may process the communication signal received by the power management communication device 210 and generate the power network characteristic table according to the processed communication signal. For example, the microprocessor 231 may generate maximum power output amounts and current power output amounts of the power distribution apparatuses of the power network characteristic table based on input current values and input voltage values of the power distribution apparatuses 100 received by the power management communication device 210.

The microprocessor 231 may generate a power network structure matrix based on the power network characteristic table. For example, the microprocessor 231 may generate transverse and longitudinal axes of the power network structure matrix based on an item for the number of power distribution apparatuses included in the power network characteristic table, and may identify a connection relationship between the power distribution apparatuses based on the power input/output of the power distribution apparatuses included in the power network characteristic table.

Also, the microprocessor 231 may visualize information about the power network (PNT) based on the power network characteristic table and the power network structure matrix, and may transmit a communication message to the display 36 for the display 36 to display the visualized information about the power network (PNT).

The microprocessor 231 may include a processor for performing logic operations and arithmetic operations, a memory for storing programs and data, and the like.

As described above, the power management apparatus 200 may generate and update the power network characteristic table and the power network structure matrix based on the communication data received from the power distribution apparatuses 100. Also, the power management apparatus 200 may display information about the power network (PNT) on the display 36 of the vehicle 1 based on the power network characteristic table and the power network structure matrix.

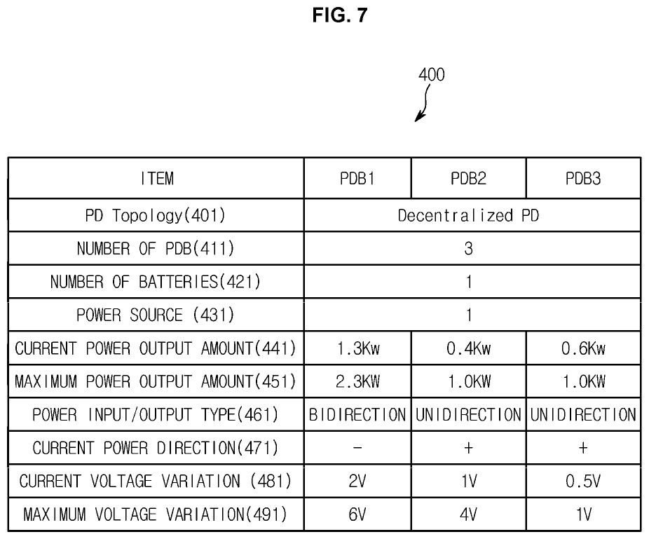

FIG. 7 shows a power network characteristic table stored in a power management apparatus of a vehicle in one form of the present disclosure.

As shown in FIG. 7, a power network characteristic table 400 may include a topology 401 of a power network, the number 411 of power distribution apparatuses, the number 421 of batteries, the number 431 of power sources (e.g., generators, solar cell etc.), a current power output amount 441 of the power distribution apparatuses, a maximum power output amount 451 of the power distribution apparatuses, a power input/output type 461 of the power distribution apparatuses, a current power direction 471 of the power distribution apparatuses, a current voltage variation 481 of the power distribution apparatuses, and a maximum voltage variation 491 of the power distribution apparatuses.

The topology 401 of the power network may be set by an initial design value. When there is no initial design value of the topology 401 of the power network, the power management apparatus 200 may identify the topology 401 of the power network, based on power/voltage and communication data of the power distribution apparatuses 100a, 100b and 100c, obtained from cranking and traveling for a certain time period.

For example, when there is a power distribution apparatus, the power management apparatus 200 may determine that the power network is a centralized power network.

When there are two power distribution apparatuses or more, and a specific power distribution apparatus has a unidirectional power input/output characteristic, the power management apparatus 200 may determine that the power network is a distributed power network, The unidirectional power input/output characteristic may be a characteristic that power is always input to one terminal of the power distribution apparatus and output from the other terminal of the power distribution apparatus.

When there are three power distribution apparatuses or more, and all of the specific power distribution apparatuses have a bidirectional power input/output characteristic, the power management apparatus 200 may determine that the power network is a ring type power network. The bidirectional power input/output characteristic may be a characteristic that power is input to one terminal of the power distribution apparatus and output from the other terminal of the power distribution apparatus and also power is input to the other terminal of the power distribution apparatus and output from the one terminal of the power distribution apparatus.

When there are two power distribution apparatuses or more, and all of the specific power distribution apparatuses have a unidirectional power input/output characteristic, the power management apparatus 200 may determine that the power network is a backbone type power network.

When there are four power distribution apparatuses or more, and if an arbitrary power distribution apparatus is turned off, another power distribution apparatus has a bidirectional power input/output characteristic, the power management apparatus 200 may determine that the power network is a mesh type power network.

The number 411 of power distribution apparatuses may be set by an initial design value. When there is no initial design value for the number 411 of power distribution apparatuses, the power management apparatus 200 may identify the number of the power distribution apparatuses 100a, 100b and 100c based on a message received through the communication network (CNT) during engine cranking.

The number 421 of batteries may be set by an initial design value, and the power management apparatus 200 may identify the number of the batteries 42 based on the output of the battery sensor 38. When there is no battery sensor 38, the power management apparatus 200 may identify the number of the batteries 42 based on information from other power apparatuses such as a converter.

The number 431 of power sources may be set by an initial design value, and the power management apparatus 200 may identify the number of power sources by communicating with the generator controller 37 and/or a solar controller.

In regard of the current power output amount 441 of the power distribution apparatuses, the power distribution apparatuses 100a, 100b and 100c may measure a current power amount using the current sensor 131 and the voltage sensor 132, and transmit the current power amount to the power management apparatus 200 through the communication network (CNT). The power management apparatus 200 may identify the current power output amount 441 of the power distribution apparatuses based on the current power amount received from the power distribution apparatuses 100a, 100b and 100c.

In regard of the maximum power output amount 451 of the power distribution apparatuses, the power management apparatus 200 may identify the maximum power output amount 451 of the power distribution apparatuses based on the current power amount received from the power distribution apparatuses 100a, 100b and 100c.

In regard of the power input/output type 461 of the power distribution apparatuses, the power distribution apparatuses 100a, 100b and 100c may measure a current value and a voltage value using the current sensor 131 and the voltage sensor 132, and may transmit the current value and the voltage value to the power management apparatus 200 through the communication network (CNT). The power management apparatus 200 may identify whether each of the power distribution apparatuses 100a, 100b and 100c has the bidirectional power input/output characteristic or the unidirectional power input/output characteristic based on the current value and the voltage value received from the power distribution apparatuses 100a, 100b and 100c.

In regard of the current power direction 471 of the power distribution apparatuses, the power distribution apparatuses 100a, 100b and 100c may measure a current power amount using the current sensor 131 and the voltage sensor 132, and may transmit the current power amount to the power management apparatus 200 through the communication network (CNT). The power management apparatus 200 may identify the current power direction 471 of the power distribution apparatuses based on the current power amount received from the power distribution apparatuses 100a, 100b and 100c.

In regard of the current voltage variation 481 of the power distribution apparatuses, the power distribution apparatuses 100a, 100b and 100c may measure a current voltage value using the voltage sensor 132, and may transmit the current voltage value to the power management apparatus 200 through the communication network (CNT). The power management apparatus 200 may identify the current voltage variation 481 of the power distribution apparatuses based on the current voltage value received from the power distribution apparatuses 100a, 100b and 100c.

In regard of the maximum voltage variation 491 of the power distribution apparatuses, the power management apparatus 200 may identify the maximum voltage variation 491 of the power distribution apparatuses based on the current voltage value received from the power distribution apparatuses 100a, 100b and 100c.

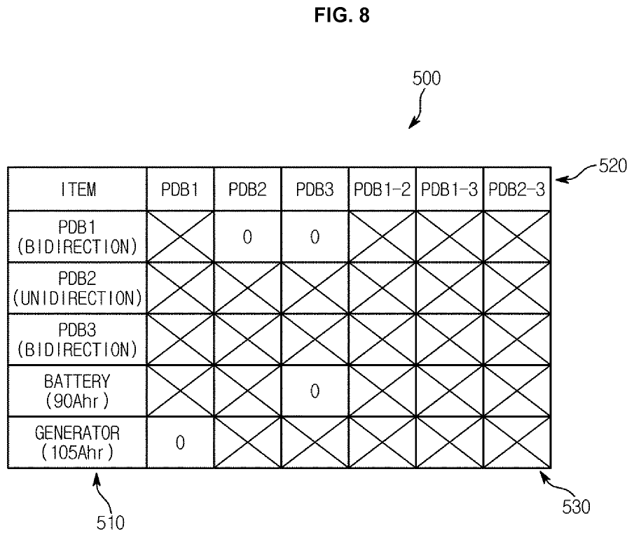

FIG. 8 shows an example of a power network structure matrix stored in a power management apparatus of a vehicle in one form of the present disclosure.

As shown in FIG. 8, a power network structure matrix 500 may include a transverse axis 520 and a longitudinal axis 510, and include a connection matrix 530 between the transverse axis 520 and the longitudinal axis 510. Apparatuses for transmitting power may be disposed on the longitudinal axis 510, and apparatuses for receiving power may be disposed on the transverse axis 520.

The longitudinal axis 510 may include items of the power distribution apparatuses 100a, 100b and 100c, the battery 42, and the generator 41, and the transverse axis 520 may include items of the power distribution apparatuses 100a, 100b and 100c, and the power lines 300 between the power distribution apparatuses. The connection matrix 530 may show connection relationships between the items of the longitudinal axis 510 and the items of the transverse axis 520.

The power management apparatus 200 may generate the longitudinal axis 510 of the power network structure matrix 500 based on the number 411 of power distribution apparatuses, the number 421 of batteries, and the number 431 of power sources in the power network characteristic table 400.

The power management apparatus 200 may generate the transverse axis 520 of the power network structure matrix 500 based on the number 411 of power distribution apparatuses included in the power network characteristic table 400.

Since the power distribution apparatuses cannot be connected to themselves, the power management apparatus 200 may eliminate any power supply relationship in which the longitudinal axis 510 meet the transverse axis 520 in the connection matrix 530.

The power management apparatus 200 may eliminate a power supply relationship in which the power distribution apparatuses 100a. 100b and 100c of the longitudinal axis 510 intersect with the power lines 300 of the transverse axis 520.

The power management apparatus 200 may identify the power supply relationship between the generator 41 and the power distribution apparatuses 100a, 100b and 100c based on the maximum power output amount 451 of the power distribution apparatuses. Since the power distribution apparatus connected to the generator 41 outputs maximum power, the power management apparatus 200 may determine that the power distribution apparatus in which the current power output amount 441 is the maximum is connected to the generator 41. For example, the power management apparatus 200 may identify the first power distribution apparatus 100a connected to the generator 41.

When the power distribution apparatuses have the same maximum power output amount 451, the power management apparatus 200 may determine that a power line connecting the power distribution apparatuses having the same current power output amount 441 is connected to the generator 41.

Since the battery 42 stores electric energy, a voltage variation of the power distribution apparatus connected to the battery 42 may be small. Also, since the battery 42 performs both charging and discharging, the power distribution apparatus connected to the battery 42 may have the bidirectional power input/output characteristic, For this reason, the power management apparatus 200 may determine that the battery 42 is connected to the power distribution apparatus having a minimum forward variation and the bidirectional power input/output characteristic. For example, the power management apparatus 200 may identify the third power distribution apparatus 100c connected to the battery 42.

Also, when the power distribution apparatuses have the same maximum voltage variation 491, the power management apparatus 200 may determine that the generator 41 is connected to a power line connecting the power distribution apparatuses having the same maximum voltage variation 491.

Also, when there are a plurality of batteries, the power management apparatus 200 may measure a maximum voltage variation while sequentially disconnecting the batteries. The power management apparatus 200 may determine that the batteries are connected to the power distribution apparatuses having the minimum value of the maximum voltage variation according to the capacity of the batteries.

Since a power distribution apparatus having the unidirectional input/output characteristic does not supply power to another power distribution apparatus, the power management apparatus 200 may eliminate a power supply relationship of the power distribution apparatus having the unidirectional input/output characteristic. For example, a power supply relationship output from he second power distribution apparatus 100b may be eliminated.

According to the method described above, the power management apparatus 200 may generate the power network structure matrix 500 from the power network characteristic table 400.

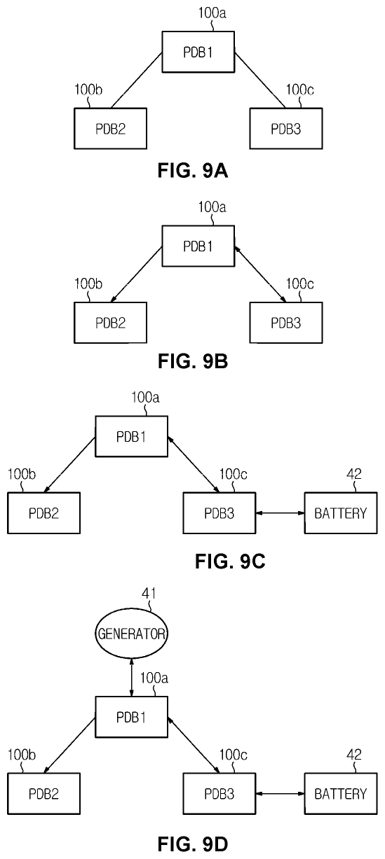

FIGS. 9A to 9D show examples of information about a power network displayed on a display of a vehicle in one form of the present disclosure.

The power management apparatus 200 may visualize the power network structure matrix 500, and the display 36 of the vehicle 1 may display image information in which the power network structure matrix 500 is visualized,

As shown in FIG. 9A, the power management apparatus 200 may visualize a connection relationship between the power distribution apparatuses 100a, 100b and 100c using the power network structure matrix 500, and may transmit the image information in which the connection relationship between the power distribution apparatuses 100a, 100b and 100c is visualized, to the display 36.

As shown in FIG. 9B, the power management apparatus 200 may visualize a power supply relationship (connection relationship and power flow) between the power distribution apparatuses 100a, 100b and 100c using the power network structure matrix 500, and may transmit the visualized image information to the display 36.

As shown in FIG. 9C, the power management apparatus 200 may visualize a power supply relationship between the battery 42 and the power distribution apparatuses 100a, 100b and 100c using the power network structure matrix 500, and may transmit the visualized image information to the display 36.

As shown in FIG. 9D, the power management apparatus 200 may visualize a power supply relationship between the generator 41, the battery 43, and the power distribution apparatuses 100a, 100b and 100c using the power network structure matrix 500, and may transmit the visualized image information to the display 36,

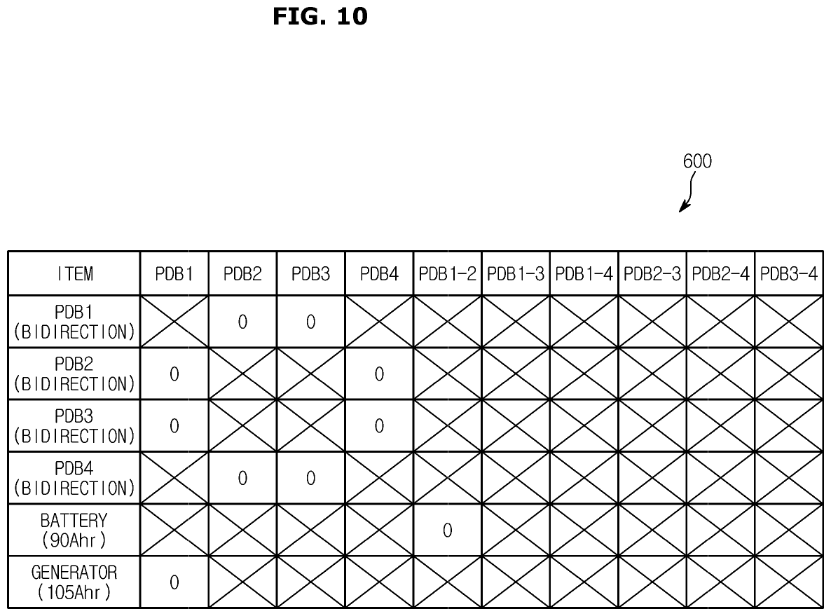

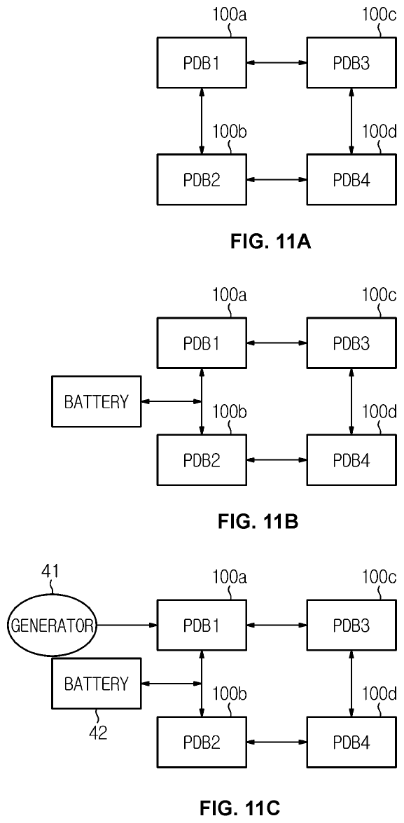

FIG. 10 shows another example of a power network structure matrix stored in a power management apparatus of a vehicle in one form and FIGS. 11A to 11C show other examples of information about a power network displayed on a display of a vehicle in another form of the present disclosure.

A power network (PNT) may include the battery 42 and the first, second, third, and fourth power distribution apparatuses 100a 100b, 100c and 100d The first, second, third, and fourth power distribution apparatuses 100a, 100b, 100c and 100d may be connected in the shape of a ring, and the power network (PNT) may have a ring topology.

The power management apparatus 200 may generate a power network structure matrix 600 as shown in FIG. 10 from the power network (PNT).

Also, the power management apparatus 200 may generate image information as shown in FIGS. 11A to 11C from the power network structure matrix 600.

For example, as shown in FIG. 11A, the power management apparatus 200 may visualize a power supply relationship between the power distribution apparatuses 100a, 100b, 100c and 100d using the power network structure matrix 600, and transmit the visualized image information to the display 36.

As shown in FIG. 11B, the power management apparatus 200 may visualize the power supply relationship between the battery 42 and the power distribution apparatuses 100a, 100b, 100c and 100d using the power network structure matrix 600, and transmit the visualized image information to the display 36.

As shown in FIG. 11C, the power management apparatus 200 may visualize a power supply relationship between the generator 41, the battery 42, and the power distribution apparatuses 100a, 100b, 100c and 100d using the power network structure matrix 600, and transmit the visualized image information to the display 36

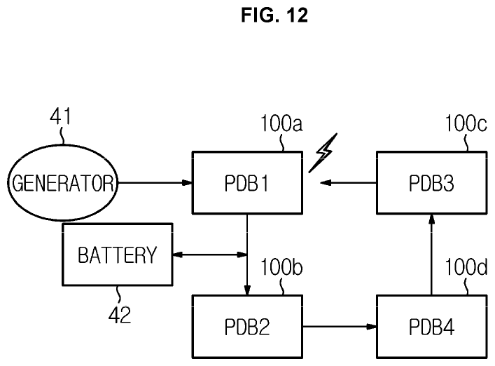

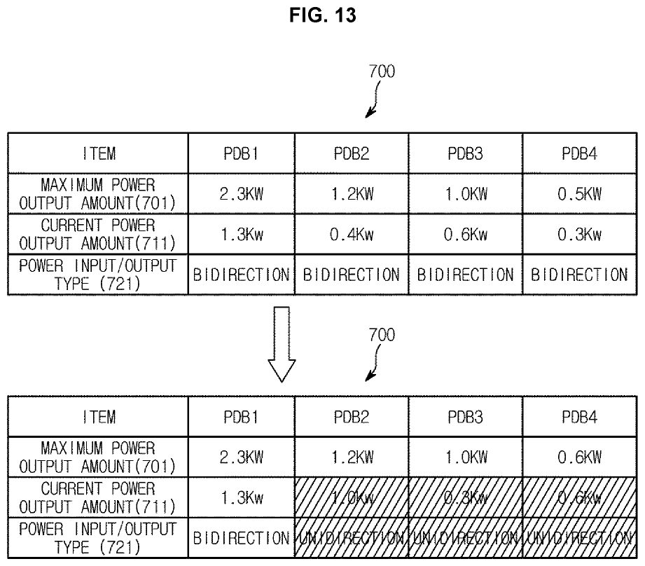

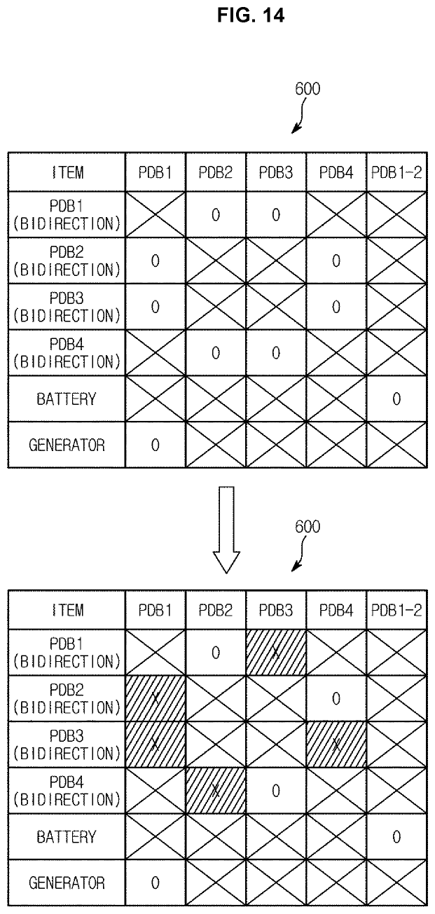

As one form of the present disclosure, FIG. 12 shows an example in which a power network of a vehicle changes, FIG. 13 shows an example in which a power network characteristic table changes by the change of the power network illustrated in FIG. 12, and FIG. 14 shows an example in which a power network structure matrix changes by the change of the power network illustrated in FIG. 12.

As illustrated in FIG. 12, the first power distribution apparatus 100a may be disconnected from the third power distribution apparatus 100c, As a result, the connection relationship between the power distribution apparatuses 100a, 100b, 100c and 100d may change, and a power network characteristic table 700 and the power network structure matrix 600 may vary.

For example, as shown in FIG. 13, a current power output amount 711 and a power input/output type 721 of the power distribution apparatuses in the power network characteristic table 700 may change. The power input/output type 721 of the second, third and fourth power distribution apparatuses 100b, 100c and 100d may change from bidirectional to unidirectional.

Also, as shown in FIG. 14, the power supply relationship from the first power distribution apparatus 100a to the third power distribution apparatus 100c in the power network structure matrix 600 may be eliminated, the power supply relationship from the second power distribution apparatus 100b to the first power distribution apparatus 100a may be eliminated, the power supply relationship from the third power distribution apparatus 100c to the first power distribution apparatus 100a may be eliminated, the power supply relationship from the third power distribution apparatus 100c to the fourth power distribution apparatus 100d may be eliminated, and the power supply relationship from fourth power distribution apparatus 100d to the second power distribution apparatus 100b may be eliminated.

The power management apparatus 200 may visualize the changed power network structure matrix 700, and the display 36 of the vehicle 1 may display the visualized image information of the changed power network structure matrix 600.

Meanwhile, the disclosed forms may be embodied in the form of a recording medium storing instructions executable by a computer. The instructions may be stored in the form of program code and, when executed by a processor, may generate a program module to perform the operations of the disclosed forms. The recording medium may be embodied as a computer-readable recording medium.

The computer-readable recording medium includes all kinds of recording media in which instructions which can be decoded by a computer are stored. For example, it may be ROM (Read Only Memory), RAM (Random Access Memory), a magnetic tape, a magnetic disk, a flash memory, an optical data storage device, or the like.

As is apparent from the above, the in the exemplary forms of the present disclosure, there may be provided a vehicle capable of detecting, when a fault occurs, a fault location and performing a safety operation, and a method of determining a power supply relationship of the vehicle.

According to another aspect of the present disclosure, there may be provided a vehicle capable of identifying the structure of a power network and the flow of power, and a method of determining a power supply relationship of the vehicle.

Although a few forms of the present disclosure have been shown and described, it would be appreciated by those skilled in the art that changes may be made in these forms without departing from the principles and spirit of the disclosure, the scope of which is defined in the present disclosure.

What is claimed is:

1. A vehicle comprising:
a generator;
a battery;
a plurality of electronic components;
at least one power distribution apparatus configured to distribute power from the generator and the battery to the plurality of electronic components; and
a power management apparatus configured to determine an electrical characteristic of each of the generator, the battery and the at least one power distribution apparatus, and configured to determine a power supply relationship between the generator, the battery and the at least one power distribution apparatus.

2. The vehicle according to claim 1, wherein the electrical characteristic comprises a number of power distribution apparatus within the vehicle, a maximum power output amount of the at least one power distribution apparatus, a power input/output characteristic of the at least one power distribution apparatus, and a maximum voltage variation of the at least one power distribution apparatus.

3. The vehicle according to claim 2, wherein the power management apparatus is configured to determine the number of the power distribution apparatus within the vehicle based on communication data received from the at least one power distribution apparatus.

4. The vehicle according to claim 2, wherein the power management apparatus is configured to identify the maximum power output amount of the at least one power distribution apparatus based on an input/output current of the at least one power distribution apparatus and a voltage applied to the at least one power distribution apparatus.

5. The vehicle according to claim 2, wherein the power management apparatus is configured to identify the power input/output characteristic of the at least one power distribution apparatus based on an input/output current of the at least one power distribution apparatus.

6. The vehicle according to claim 2, wherein the power management apparatus is configured to identify the maximum voltage variation of the at least one power distribution apparatus based on a voltage applied to the at least one power distribution apparatus.

7. The vehicle according to claim 2, wherein the power management apparatus is configured to determine the power supply relationship based on the number of the power distribution apparatus within the vehicle and the power input/output characteristic of the at least one power distribution apparatus.

8. The vehicle according to claim 2, wherein the power management apparatus is configured to determine the power supply relationship between the at least one power distribution apparatus and the generator based on the maximum power output amount of the at least one power distribution apparatus.

9. The vehicle according to claim 2, wherein the power management apparatus is configured to determine the power supply relationship between the a east one power distribution apparatus and the battery based on the maximum voltage variation of the at least one power distribution apparatus.

10. The vehicle according to claim 1, further comprising a display,
wherein the power management apparatus is configured to display an image representing the power supply relationship between the generator, the battery, and the at least one power distribution apparatus, on the display.

11. A control method of a vehicle including a plurality of electronic components, the control method comprising:
distributing power, by at least one power distribution apparatus, from a generator and a battery to the plurality of electronic components; and
determining, by a power management apparatus, an electrical characteristic of each of the generator, the battery and the at least one power distribution apparatus, and a power supply relationship between the generator, the battery and the at least one power distribution apparatus.

12. The control method according to claim 11, wherein the electrical characteristic comprises a number of power distribution apparatus within the vehicle, a maximum power output amount of the at least one power distribution apparatus, a power input/output characteristic of the at least one power distribution apparatus, and a maximum voltage variation of the at least one power distribution apparatus.

13. The control method according to claim 12, further comprising determining, by the power management apparatus, the number of the power distribution apparatus within the vehicle based on communication data received from the at least one power distribution apparatus.

14. The control method according to claim 12, further comprising identifying, by the power management apparatus, the maximum power output amount of the at least one power distribution apparatus based on an input/output current of the at least one power distribution apparatus and a voltage applied to the at least one power distribution apparatus.

15. The control method according to claim 12, further comprising identifying, by the power management apparatus, the power input/output characteristic of the at least one power distribution apparatus based on an input/output current of the at least one power distribution apparatus.

16. The control method according to claim 12, further comprising identifying, by the power management apparatus, the maximum voltage variation of the at least one power distribution apparatus based on a voltage applied to the at least one power distribution apparatus.

17. The control method according to claim 12, further comprising determining, by the power management apparatus, the power supply relationship based on the number of the power distribution apparatus within the vehicle and the power input/output characteristic of the at least one power distribution apparatus.

18. The control method according to claim 12, further comprising determining, by the power management apparatus, the power supply relationship between the at least one power distribution apparatus and the generator based on the maximum power output amount of the at least one power distribution apparatus.

19. The control method according to claim 12, further comprising determining, by the power management apparatus, the power supply relationship between the at least one power distribution apparatus and the battery based on the maximum voltage variation of the at least one power distribution apparatus.

20. The control method according to claim 11, further comprising displaying an image representing the power supply relationship between the generator, the battery, and the at least one power distribution apparatus on a display.
